(19) United States
(12) Patent Application Publication
(10) Pub. No.: US 2026/0010286 A1
(43) Pub. Date: Jan. 8, 2026

(54) CONTROLLER AND SYSTEM FOR STATE COMPRESSION IN MEMORY CELL

(71) Applicant: InnoGrit Technologies Co., Ltd., Shanghai (CN)

(72) Inventors: Chenrong Xiong, San Jose, CA (US); Youngjoon Choi, Shanghai (CN); William Fu, San Jose, CA (US); Jie Chen, Shanghai (CN)

(21) Appl. No.: 18/764,088

(22) Filed: Jul. 3, 2024

(51) Int. Cl. G06F 3/06

(52) U.S. Cl. CPC G06F 3/0608; G06F 3/0659; G06F 3/0679

(57) ABSTRACT

Disclosed is a controller and system for state compression in memory cell. The controller comprises a processor. In one embodiment, the processor is configured to set values of D bits, based on values of M bits. M is an integer greater than 0 and D is an integer greater than 0. The controller is configured to write the values of D bits and the values of M bits into a memory cell of a non-volatile memory. In another embodiment, the controller is configured to read values of M bits and values of D bits from a memory cell of a non-volatile memory, and the controller comprises a processor configured to determine values of the M bits based on the values of the D bits.

### TECHNICAL FIELD

The disclosure herein relates to state compression in a memory cell.

### BACKGROUND

As Solid-State Drive (SSD) technology continues to advance, different types of memory cells have been developed to store data, including Single-Level Cell (SLC), Multi-Level Cell (MLC), Triple-Level Cell (TLC), Quad-Level Cell (QLC) and even Penta-Level Cell (PLC).

For a memory cell of a SSD, different states are defined by the read reference voltage Vth. For example, in the case of SLC, one bit (or one level) with two states, “1” and “0”, are defined using a single read reference voltage Vth. In the case of MLC, two bits (or two levels) with four states, “11”, “10”, “01” and “00”, are defined using three read reference voltages, Vth0, Vth1 and Vth2. In the case of TLC, three bits (or three levels) with eight states, “111”, “110”, “101”, “100”, “011”, “010”, “001” and “000”, are defined using seven read reference voltages. And, in the case of QLC, four bits (or four levels) with sixteen states, “1111”, “1110”, “1101”, “1100”, “1011”, “1010”, “1001”, “1000”, “0111”, “0110”, “0101”, “0100”, “0011”, “0010”, “0001” and “0000”, are defined by utilizing fifteen read reference voltages. The case of PLC follows a similar pattern.

SLC cells store one bit of data per cell, offering high performance, endurance, and reliability. They have faster read and write speeds but are more expensive and have lower capacity compared to other cell types.

In an SSD, static data, such as log files, system configuration data, and firmware, are stored in SLC cells. These data are written once and rarely changed and require high reliability. Therefore they are stored in SLC cells to reduce wear and maintain reliability.

Besides these static data, a logical address to physical address mapping table may be written into SLC cells when power down happens. When the power is restored, the firmware will read the mapping table from SLC cells to rebuild the table.

SLC cells may be used as a program data buffer. In this use scenario, the data to program are written into SLC cells first, and then moved into TLC cells in a background programming operation.

Since SLC cells have a lower raw bit error rate and are more reliable than the MLC/TLC/QLC cells, SLC cells usually are used to keep above-mentioned critical data.

A TLC/QLC could be used as an SLC cell or a TLC/QLC cell. In an example, 20% of all cells in an SSD may be used as SLC cells.

If the number of SLC cells (including TLC/QLC cells used as SLC cells) can be reduced, the provision for TLC/QLC cell will be increased. Hence, the write-amplification-factor can be decreased, and the performance and lifetime of the SSD can be improved as well.

It might be helpful to reduce the SLC cells while still meeting the data storage requirements that were previously fulfilled by the SLC cells.

Although the disclosure may use the SSD to explain state compression, state compression may be applicable to other memories.

### SUMMARY

In one embodiment, a controller has a processor configured to set values of D bits, based on values of M bits. M is an integer greater than 0 and D is an integer greater than 0. The controller is configured to write the values of D bits and the values of M bits into a memory cell of a non-volatile memory.

In another embodiment, a controller is configured to read values of M bits and values of D bits from a memory cell of a non-volatile memory. M is an integer greater than 0 and D is an integer greater than 0. The controller has a processor configured to determine values of the M bits based on the values of the D bits.

In yet another embodiment, a system includes the controller. The system is a solid-state drive (SSD), a flash drive, a mother board, a processor, a computer, a server, a gaming device, or a mobile device.

The foregoing paragraphs have been provided by way of general introduction and are not intended to limit the scope of the following claims. The described embodiments, together with further advantages, will be best understood by reference to the following detailed description taken in conjunction with the accompanying drawings.

### BRIEF DESCRIPTION OF FIGURES

FIG. 1 schematically shows a system in accordance with an embodiment.

FIG. 2 schematically shows examples of state compression for a TLC cell.

FIG. 3 schematically shows examples of state compression for a QLC cell.

FIG. 4 shows the Gray code state representation in a normal TLC mode.

FIG. 5 shows the 8-to-4 compressed state representation of TLC Example 1.

FIG. 6 shows the states representation in a normal TLC mode.

FIG. 7 schematically shows shifts of read reference voltages for read retry of UP.

FIG. 8 shows the 8-to-4 compressed state representation of TLC Example 2.

FIG. 9 shows the Gray code state representation in another normal TLC mode.

FIGS. 10-13 show four 8-to-4 TLC state compression schemes.

FIG. 14 shows the Gray code state representation in a normal QLC mode.

FIG. 15 shows the 16-to-8 compressed state representation of QLC Example 1.

FIG. 16 shows the 16-to-4 compressed state representation of QLC Example 2.

FIG. 17 is a schematic flow chart of a programing operation for a wordline with a fully protected state compression scheme of the disclosure.

FIG. 18 is a schematic flow chart of a read operation for a wordline with a fully protected state compression scheme of the disclosure.

FIG. 19 schematically shows partial page usage of state compression scheme in a TLC block.

### DETAILED DESCRIPTION

Embodiments according to the present disclosure will now be described in detail with references to the accompanying figures. Like elements in the various figures are denoted by like reference numerals for consistency.

The disclosure proposes a state compression scheme which could provide better reliability on data storage in an SSD. The state compression scheme can be used to reduce the number of SLC blocks in an SSD to improve the lifetime of the SSD.

A state compression scheme uses a smaller number of states of a memory cell of a non-volatile memory (NVM) for data storage than that the memory cell physically has. For example, a TLC cell physically has 8 states but only 2 or 4 states are used for data storage under a state compression scheme. Namely, under a state compression scheme, the TLC cell is used as an SLC cell or an MLC cell. Similarly, a QLC cell physically has 16 states but only 2 or 4 or 8 states are used for data storage under a state compression scheme. Namely, under a state compression scheme, the QLC cell is used as an SLC cell, an MLC cell or a TCL cell.

In other words, although there are 8 states in a TLC cell and 16 states in a QLC cell, state compression can be achieved by applying an encoding scheme to programmed data such that the number of states of a wordline in TLC or QLC is reduced and the margin between two immediate neighboring states is larger than the normal wordline of TLC/QLC. Therefore, a state-compressed wordline might have better reliability and a lower raw bit error rate (BER).

Similarly, the proposed scheme can be applied to MLC and PLC.

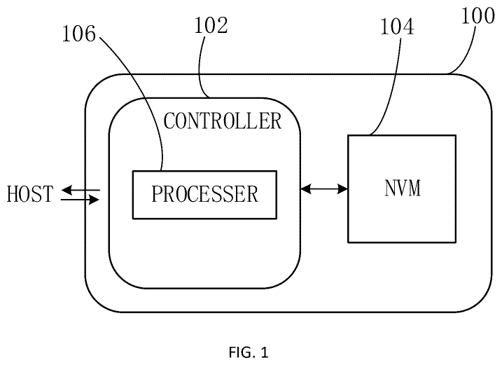

FIG. 1 schematically shows a system in accordance with an embodiment.

In some embodiments, the system is a solid-state drive (SSD), a flash drive, a mother board, a processor, a computer, a server, a gaming device, or a mobile device.

The system 100 may comprise a controller 102 and a non-volatile storage device (NVM) 104. In some embodiments, the system 100 may serve as a storage system, and provide data storage and/or access to stored data to a host when it is coupled to the host.

The storage device 104 may be a non-volatile memory (NVM), for example, a NAND device. The system 100 may comprise a plurality of non-volatile storage devices and the storage device 104 may be shown as a representative for the plurality of non-volatile storage devices.

The controller 102 comprises a processor 106. The processor 106 may be a computer processor, such as, but not limited to, a microprocessor or a microcontroller.

The controller 102 may write data into the storage device 104 and read data from the storage device 104. The processor 106 may perform some process on some data to be written into a memory cell of the storage device 104, or some data read from the memory cell of the storage device 104.

The memory cell is the smallest physical storage unit in the storage device 104. In some embodiments, the memory cell may be a NAND cell. In the cases of SLC, MLC, TLC, QLC and PLC, one memory cell is configured to store data of 1, 2, 3, 4 and 5 bits respectively, by defining 2, 4, 8, 16 and 32 states with 1, 3, 7, 15 and 31 read reference voltages. Data are written into a memory cell by programing a voltage in a range corresponding to values of bits of the data into the memory cell, and is read out from the memory cell by comparing the threshold voltage of the memory cell with the read reference voltages.

The term “bit” means a binary digit, which is the basic unit of information in computing and digital communications, as well as in data storage. It is commonly represented as a 0 or 1, corresponding to the two possible states of a digital signal or the two values in binary code.

Suppose the memory cell is originally configured to store data of N bits, with 2^{N} states. Here, N is an integer greater than 1. For example, N=2 for the MLC mode; N=3 for the TLC mode; N=4 for the QLC mode; N=5 for the PLC mode.

An MLC cell is configured to store 2 bits of data, which can be mapped to 2 pages, namely a Lower Page “LP” and an Upper Page “UP”. A TLC cell is configured to store 3 bits of data, which can be mapped to 3 pages, namely a Lower Page “LP”, an Upper Page “UP”, and an extra Page “XP”. A QLC cell is configured to store 4 bits of data, which can be mapped to 4 pages, namely a Lower Page “LP”, a Middle Page “MP”, an Upper Page “UP”, and a Top Page “TP”.

The 2^{N} states may be compressed into 2^{M} states under a state compression scheme, corresponding to M bits. In other words, the data expected to be written into the memory cell has M bits. Here, M is an integer greater than 0, for example, M=1, M=2, M=3 or M=4. The M bits of data may be data expected to be written into the memory cell.

Since the memory cell is originally designed and configured for N bits, for example, in the TLC mode with N=3 or in the QLC mode with N=4, a wordline connected to the memory cell is configured for N bits (or N pages). Under a state compression scheme, there are still D=N−M bits (pages) of data needed for programming, which can be referred to as “redundancy bits” or “redundancy pages”. Here, D is an integer greater than 0. For example, D=1 or D=2.

In the case of D=1, M=1 for the MLC mode, M=2 for the TLC mode, M=3 for the QLC mode, M=4 for the PLC mode.

In the case of D=2, M=1 for the TLC mode, M=2 for the QLC mode, M=3 for the PLC mode.

The controller 102 can perform write operations and/or read operations on the memory cell of the non-volatile memory (NVM) 104, which may be referred to as “writing embodiments” or “reading embodiments”. It shall be understood that, when a controller 102 is configured to read data from the non-volatile memory (NVM) 104, it does not mean that the data in the non-volatile memory (NVM) 104 is written by the controller 102.

In a writing embodiment, the processor 106 is configured to set values of the D bits, based on values of the M bits. For example, the processor 106 is configured to set the values of the D bits using one or more results of one or more logic operations (e.g., conjunction, disjunction, negation, exclusive disjunction) of one or more of the values of the M bits.

In some embodiments, the processor 106 is configured to set the value of at least one bit among the D bits based on the value of only one bit among the M bits.

In some other embodiments, the processor 106 is configured to set the value of at least one bit among the D bits based on the values of only two bits among the M bits.

The controller 102 is configured to write the values of D bits and the values of M bits into a memory cell of the non-volatile memory (NVM) 104.

In some situations, the D bits of data derived from the values of the M bits may be used to recover or correct one or more missing or error bits among the M bits. This may be performed, for example, when checking, recovering, or correcting one or more bits among the M bits.

In a reading embodiment, the controller 102 is configured to read values of M bits and values of D bits from a memory cell of the non-volatile memory (NVM) 104, and the processor 106 is configured to determine values of the M bits based on the values of the D bits.

In some embodiments, the processor 106 is configured to determine the value of at least one bit among the M bits based on the value of only one bit among the D bits.

In some other embodiments, the processor 106 is configured to determine the value of at least one bit among the M bits based on the values of only two bits among the D bits.

In the embodiments and examples described above, N=M+D. It shall be understood that, in some other embodiments, N=M+D+E is also possible. Here, E is an integer greater than 0. The D redundancy bits is set based on the values of the M bits of data expected to be written to the memory cell, while the further E bits may be set in any other suitable scheme. The controller 102 is configured to write the values of E bits, the values of D bits and the values of M bits into a memory cell of the non-volatile memory (NVM) 104.

Hereinafter, some schemes for setting values of the D bits or determining values of the M bits will be described. In the setting schemes, logic operations such as “negation”, “disjunction” and “exclusive disjunction” will be used.

The “negation” of a bit value, also known as the logical “NOT” operation and sometimes designated by the simple “˜”, flips or inverts the state of the bit value. For example, the negation of the bit value 0 would be 1, and the negation of the bit value 1 would be 0.

The “disjunction” of two bits, also known as the logical “OR” operation and sometimes designated by the symbol “|”, returns 1 if at least one of the bits is 1. Otherwise, it returns 0.

Here is the truth table for the disjunction operation:

| Bit A | Bit B | A OR B |
|---|---|---|
| 0 | 0 | 0 |
| 0 | 1 | 1 |
| 1 | 0 | 1 |
| 1 | 1 | 1 |

As shown in the truth table, if either bit A or bit B (or both) is 1, the result of the disjunction operation will be 1. Only when both bits are 0 will the result be 0.

The “exclusion disjunction” of two bits, also known as the logical “XOR” (exclusive OR) operation, returns 1 if the two bits have different values. Otherwise, it returns 0.

Here is the truth table for the exclusion disjunction operation:

| Bit A | Bit B | A XOR B |
|---|---|---|
| 0 | 0 | 0 |
| 0 | 1 | 1 |
| 1 | 0 | 1 |
| 1 | 1 | 0 |

As shown in the truth table, the result of the exclusion disjunction operation is 1 when the two bits have different values (one is 0 and the other is 1). If both bits are the same (either both 0 or both 1), the result is 0.

In a writing embodiment, the processor is configured to set the value of at least one bit among the D bits to the value of one bit among the M bits.

For example, for a TLC cell, if LP and UP are designed to be used to store the M (here M=2) bits of the data, and XP is designed to be used to store the one bit among the D (here D=1) bits, then the value of XP can be set to be the value of UP or LP, i.e., XP=UP, or XP=LP.

Accordingly, in a reading embodiment, the processor is configured to determine the value of at least one bit among the M bits as the value of one bit among the D bits.

For example, for a TLC cell, LP and UP are designed to be used to store the M (here M=2) bits of the data, and XP is designed to be used to store the one bit among the D (here D=1) bits, and the value of XP is set to be the value of UP (or LP), i.e., XP=UP, (or XP=LP) when writing data into the memory cell. If UP (or LP) cannot be decoded from the memory cell while XP can, then the value of UP (or LP) can be determined as the value of XP.

In another writing embodiment, the processor is configured to set the value of at least one bit among the D bits to a negation of an exclusive disjunction of the values of two bits among the M bits.

For example, for a TLC cell, if LP and UP are designed to be used to store the M (here M=2) bits of the data, and XP is designed to be used to store the one bit among the D (here D=1) bits, then the value of XP can be set as XP=NOT (UP XOR LP).

Alternative, if LP and XP are designed to be used to store the M (here M=2) bits of the data, and UP is designed to be used to store the one bit among the D (here D=1) bits, then the value of UP can be set as UP=NOT (XP XOR LP).

Accordingly, in a reading embodiment, the processor is configured to determine the value of at least one bit among the M bits as an exclusive disjunction of the value of another bit among the M bits and a negation of the value of one bit among the D bits, or configured to determine the value of at least one bit among the M bits as an exclusive disjunction of the value of one bit among the D bits and a negation of the value of another bit among the M bits.

For example, for a TLC cell, LP and UP are designed to be used to store the M (here M=2) bits of the data, and XP is designed to be used to store the one bit among the D (here D=1) bits, and the value of XP is set as XP=NOT (UP XOR LP). If XP and UP can be decoded from the memory cell while LP cannot, LP can be determined based on LP=(NOT XP) XOR UP. If XP and LP can be decoded while UP cannot, UP can be determined based on UP=(NOT XP) XOR LP.

In another example, LP and XP are designed to be used to store the M (here M=2) bits of the data, and UP is designed to be used to store the one bit among the D (here D=1) bits, the value of UP is set as UP=NOT (XP XOR LP). If UP and LP can be decoded from the memory cell while XP cannot, XP can be determined based on XP=(NOT UP) XOR LP. If UP and XP can be decoded while LP cannot, LP can be determined based on LP=(NOT UP) XOR XP.

In another example, UP and XP are designed to be used to store the M (here M=2) bits of the data, and LP is designed to be used to store the one bit among the D (here D=1) bits, the value of LP is set as LP=NOT (XP XOR UP). If LP and UP can be decoded from the memory cell while XP cannot, XP can be determined based on XP=(NOT LP) XOR UP. If LP and XP can be decoded while UP cannot, UP can be determined based on UP=(NOT LP) XOR XP.

In another writing embodiment, the processor is configured to set the value of at least one bit among the D bits to a disjunction of a negation of the value of one bit among the M bits and a negation of the value of another bit among the M bits.

For example, for a TLC cell, if LP and UP are designed to be used to store the (here M=2) bits of the data, and XP is designed to be used to store the one bit among the (here D=1) bits, then the value of XP can be set as XP=(˜LP)|(˜UP), i.e., XP=(NOT LP) OR (NOT UP).

In another writing embodiment, the processor is configured to set the value of at least one bit among the D bits to a disjunction of the value of one bit among the M bits and a negation of the value of another bit among the M bits.

For example, for a TLC cell, if LP and UP are designed to be used to store the (here M=2) bits of the data, and XP is designed to be used to store the one bit among the (here D=1) bits, then the value of XP can be set as XP=LP|(˜UP), i.e., XP=(LP) OR (NOT UP).

In another writing embodiment, the processor is configured to set the value of at least one bit among the D bits to an exclusive disjunction of the values of two bits among the M bits.

For example, for a TLC cell, if LP and XP are designed to be used to store the (here M=2) bits of the data, and UP is designed to be used to store the one bit among the (here D=1) bits, then the value of UP can be set as UP=XP XOR LP.

In another writing embodiment, the processor is configured to set the value of at least one bit among the D bits to an exclusive disjunction of the value of a first bit and an exclusive disjunction of the value of a second bit and the value of a third bit, wherein the first bit, the second bit and the third bit are among the M bits.

For example, for a QLC cell, if LP, MP and UP are designed to be used to store the (here M=3) bits of the data, and TP is designed to be used to store the one bit among the (here D=1) bits, then the value of TP can be set as TP=LP XOR MP XOR UP.

It shall be understood that, if M is larger than 3, the first bit, the second bit and the third bit can be any three bits among the M bits. The first bit, the second bit and the third bit do not mean any particular bits. For example, the first bit is not necessarily the most significant bit.

Hereinafter, state compression effects generated by the scheme of this disclosure will be described with some examples.

According to the scheme of the disclosure, although there are eight states in TLC and 16 states in QLC, the state compression can be achieved by applying an encoding scheme to programmed data such that the number of states of a wordline in TLC or QLC is reduced and the margin between two immediate neighboring states is larger than the normal wordline of TLC/QLC due to the fine-programming operation. Therefore, a state-compressed wordline has better reliability and lower raw BER.

Similarly, the proposed scheme can be applied to MLC and PLC as well.

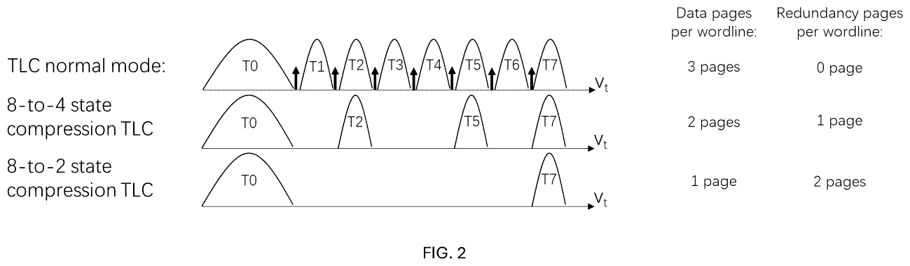

FIG. 2 schematically shows examples of state compression for a TLC cell.

As shown in FIG. 2, in a normal TLC mode, 8 states T0, T1, T2, T3, T4, T5, T6 and T7 are defined by using 7 read reference voltages Vth shown as 7 upward-pointing arrows. There are 3 data pages and 0 redundancy page per wordline.

As a TLC cell is applied with an 8-to-4 state compression scheme, four states which are not adjacent to each other in the original list of 8 states, e.g., T0, T2, T5, T7 remain. There are 2 data pages and 1 redundancy page per wordline.

As a TLC cell is applied with an 8-to-2 state compression scheme, 2 states which are not adjacent to each other in the original list of 8 states, e.g., T0 and T7 remain. There are 1 data page and 2 redundancy pages per wordline.

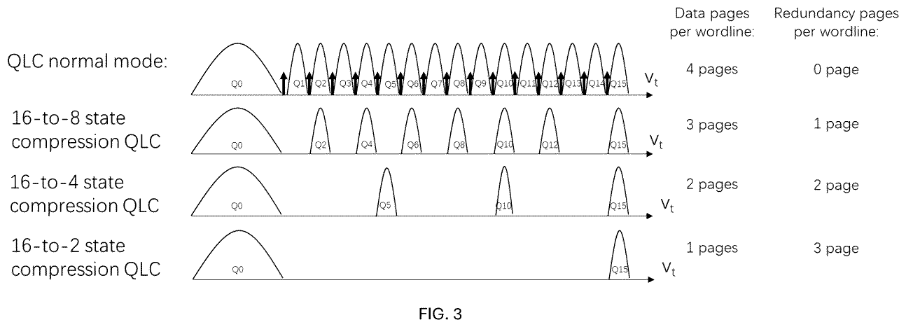

FIG. 3 schematically shows examples of state compression for a QLC cell.

As shown in FIG. 3, in a normal QLC mode, 8 states Q0, Q1, Q2, Q3, Q4, Q5, Q6, Q7, Q8, Q9, Q10, Q11, Q12, Q13, Q14 and Q15 are defined by using 15 read reference voltages Vth shown as 15 upward-pointing arrows. There are 4 data pages and 0 redundancy pages per wordline.

As a QLC cell is applied with a 16-to-8 state compression scheme, four states which are not adjacent to each other in the original list of 16 states, e.g., Q0, Q2, Q4, Q6, Q8, Q10, Q12 and Q15 remain. There are 3 data pages and 1 redundancy page per wordline.

As a QLC cell is applied with a 16-to-4 state compression scheme, four states which are not adjacent to each other in the original list of 16 states, e.g., Q0, Q5, Q10, Q15 remain. There are 2 data pages and 2 redundancy pages per wordline.

As a QLC cell is applied with a 16-to-2 state compression scheme, 2 states which are not adjacent to each other in the original list of 16 states, e.g., Q0 and Q15 remain. There are 1 data page and 3 redundancy pages per wordline.

From the above description, the state compression scheme provides a trade-off between the data reliability and the overhead to store critical data for SSD.

In the conventional SSD with TLC Flash NAND without state compression scheme, blocks used as SLC region is about 20% of the overall flash NAND blocks. If we use 4-state compression TLC to replace SLC region, only 10% of the overall blocks are needed. The other 10% blocks can be used as TLC region to provide a higher provision rate. Hence, the overhead to store critical data and the overhead for data buffer is half of the conventional SSD.

In some embodiments, instead of using SLC to store critical data, state compressed MLC can be used to store the critical data.

A TLC cell stores 8 states which can be represented by 8 three-bit binary codes. The corresponding relationships between the 8 three-bit binary codes and the 8 states can be established using different sorting methods.

Gray coding is a binary numeral system that represents successive values in such a way that only one bit changes between consecutive values.

In a Gray-coded state representation, each state is encoded using a binary code where adjacent states differ by only one bit. This helps to reduce the possibility of errors due to noise or signal distortion during transmission or processing.

For a given Gray-coding state representation, there are multiple state compression schemes, some schemes, which may be called as “fully protected state compression schemes”, provide better data protection than other schemes.

Several examples of state compression schemes will be described in more detail hereinafter.

### TLC Example 1

This is an example compressing 8 states to 4 states for a TLC cell.

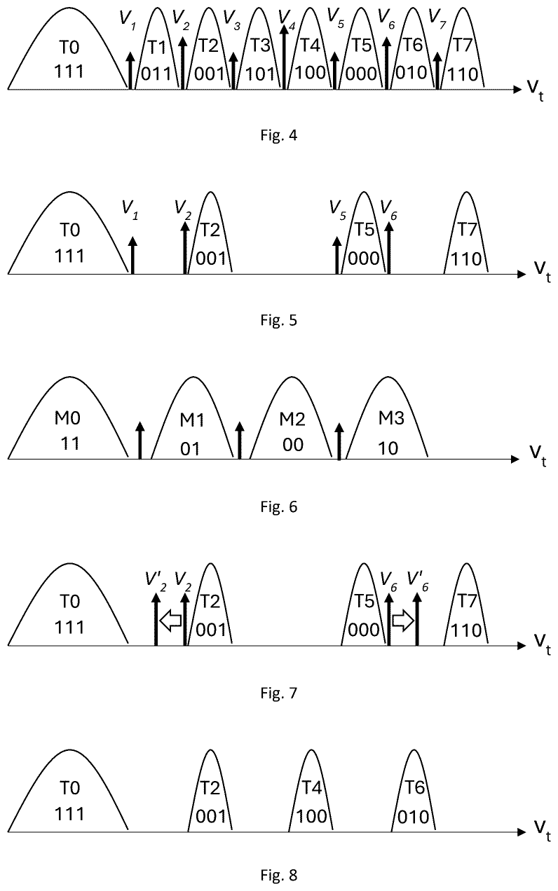

FIG. 4 shows the Gray code state representation in a normal TLC mode, which can be used in this example.

As shown in FIG. 4, in this Gray coding rule, 8 states T0, T1, T2, T3, T4, T5, T6 and T7 are mapped to 8 three-bit binary codes 111, 011, 001, 101, 100, 000, 010 and 110, respectively. As mentioned before, the first (left) bit corresponds to XP (extra Page), the middle bit corresponds to UP (Upper Page), and the last (right) bit corresponds to LP (Lower Page).

The 8 states are defined by 7 read reference voltages V1 to V7.

LP can be determined by only one read reference voltage V4, shown by the longest upward-pointing arrow.

UP can be determined by two read reference voltages V2 and V6, shown by middle-length upward-pointing arrows. If the threshold voltage of the cell is between V2 and V6, then UP=0. If the threshold voltage of the cell is not between V2 and V6, then UP=1.

XP can be determined by four read reference voltages V1, V3, V5 and V7, shown by the shortest upward-pointing arrows.

By setting XP=LP, only four states remain, namely, 111, 001, 000 and 110. And thus, the 8 states of normal TLC mode are compressed into 4 states.

In this example, extra Page (XP) data is encoded to follow Upper Page (UP) data (XP=LP), which results in a state compression.

FIG. 5 shows the 8-to-4 compressed state representation of TLC Example 1.

By state compression, a TLC mold memory cell is now can be used in an MLC mold.

In TLC example 1, UP bit is protected. If UP can not be decoded when reading the value of the bits written in the memory cell, while XP can be decoded, UP can be recovered by UP=XP.

FIG. 6 shows the states representation in a normal MLC mode.

A comparison of FIG. 5 and FIG. 6 shows the difference between TLC with 8-to-4 state compression and normal MLC. Although both FIG. 5 and FIG. 6 have 4 states per cell, the MLC states are closer to one another than the TLC with 8-to-4 state compression. The wider valley windows may provide lower RBER (Raw Bit Error Rate).

The cell distribution of double-encoding in TLC mode (as shown in FIG. 5) is much better than MLC mode (as shown in FIG. 6) since NAND applies fine-programming mode of TLC operation as opposed to MLC program operation. This would ensure more reliable data and a lower RBER, and thus provides another way to store the critical data and reduce SLC blocks required.

Furthermore, extra page (XP) provides another protection to upper page (UP).

If upper page (UP) cannot be decoded while extra page (XP) can be decoded, data of upper page (UP) can be recovered by decoding extra page (XP).

However, data of lower page (LP) is not protected by data of XP and UP. Therefore, this scheme is not a fully protected state compression scheme.

With the state compression scheme as shown in FIG. 5, a voltage between V1 and V2, or V2 (preferred), or V1 can be used to read the UP bit.

In TLC Example 1, the probability of lower page (LP) error is extremely low for the following reasons.

First, unlike upper pages (UPs) and extra pages (XPs) applying two internal reads, lower page (LP) applies only one single read by which error rate is lower.

Second, since T3 and T4 states do not exist with the proposed scheme, the margin of read reference voltage Vref4 (V4) against neighboring states is increased greatly and lowers RBER a lot.

On the other hand, while read margin for lower page (LP) Vref is improved for both side of neighboring states, read margins of UP and XP Vrefs are improved for only one side.

For example, XP Vrefs (V1, V3, V5, and V7) get increased read-margin to the right side for states T1 and T3 and to the left side for states T4 and T6.

UP Vrefs (V2 and V6) get increased read-margin to the right side for state T6 and to the left side for state T1.

As shown in FIG. 5, the default Vrefs of UP and XP in Example 1 are not aligned to the center of new valley windows anymore.

Now that narrow margin points are well known, read-retry upon UECC can apply Vrefs shifted to the center of new valley windows for a smaller RBER and a higher probability of successful decoding as shown in FIG. 5.

FIG. 7 schematically shows shifts of read reference voltages for read retry of UP.

As shown in FIG. 7, read reference voltage V2 for reading UP can be shifted from the right side of a valley window between T0 and T2 to the middle of the valley window, i.e., V′₂, and read reference voltage V6 for reading UP can be shifted from the left side of a valley window between T5 and T7 to the middle of the valley window, i.e., V′₆.

### TLC Example 2

In TLC example 2, the same Gray coding rule as shown in FIG. 4 is used for normal TLC mode.

In this example, the XP page is set by XP=NOT (UP XOR LP).

FIG. 8 shows the 8-to-4 compressed state representation of TLC Example 2.

As shown in FIG. 8, the remaining 4 states are T0 (111), T2 (001), T4 (100) and T6 (010).

While reading from the memory cell, if there is only one page which cannot be decoded, it can be recovered by using data of the other two pages.

Hence, extra page (XP) provides another level of protection for both upper page (UP) and lower page (LP).

Therefore, the state compression scheme of this example is a fully protected state compression scheme.

It shall be noted that, for an 8-to-4 state compression TLC scheme, although after programming, there are only four states, which represents two pages of user data. Since the wordline is in TLC mode, three pages of data are still needed for programming. The remaining page is used as redundancy page.

In some embodiments, any two of the three pages can be used for user data while the left one page can be used for redundancy page. In some embodiments, some assignment of the three pages to data page and redundancy page will be preferred or not preferred.

For the 8-to-4 state compression scheme shown in TCL Example 1, based on Gray coding rules for states shown in FIG. 4, (UP, LP) or (XP, LP) can be used to store two pages of user data, but (XP, UP) is not preferred.

For (UP, LP) representation, XP would be a redundant page and provides another copy of UP.

Similarly, if (XP, LP) representation is used, UP would be a redundant page and provides another copy of XP.

However, since LP has a lower probability of decoding failure compared to UP and XP, it is not preferred to use LP as redundant page. One of UP and XP can be used as redundant page to protect the other one of the two pages.

For the 8-to-4 state compression scheme shown in TCL Example 2, data page could be any two pages: (LP, UP), (LP, XP), or (UP, XP). The remaining page is the redundancy page.

To reduce the read latency, (LP, UP) will be used as data page and XP will be used as redundancy page, since there is only one read reference voltage Vref (V4) for LP, two read reference voltages Vrefs (V₂, V₆) for UP, while four read reference voltages Vrefs (V₁, V₃, V₅, V₇) for XP.

### TLC Example 3

The Gray-code state representation used for TLC in this example is different from TCL Example 1 and 2.

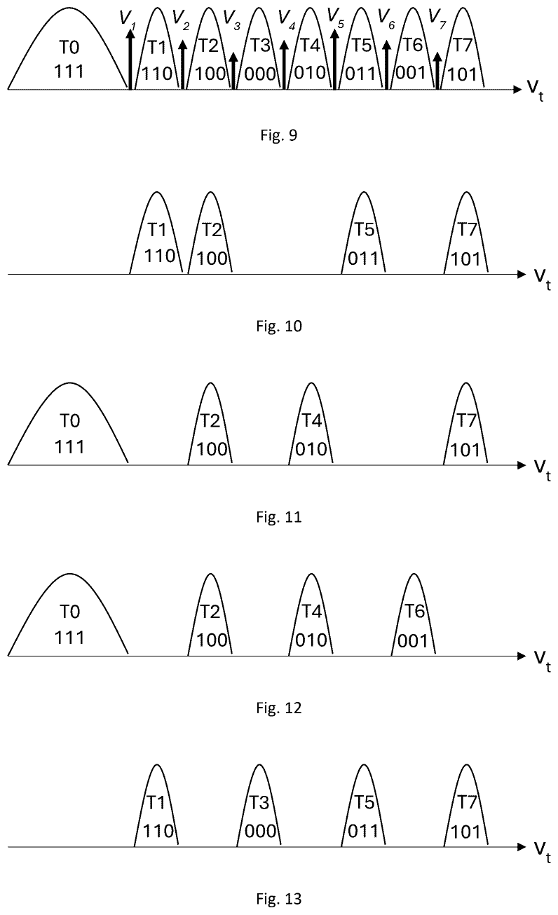

FIG. 9 shows the Gray code state representation in another normal TLC mode used in TLC Example 3.

As shown in FIG. 9, in this Gray coding rule, 8 states T0, T1, T2, T3, T4, T5, T6 and T7 are mapped to 8 three-bit binary codes 111, 110, 100, 000, 010, 011, 001 and 101, respectively. The 8 states are defined by 7 read reference voltages V₁ to V₇.

Specifically, there are two read reference voltages Vrefs (V₁, V₅) for LP; two read reference voltages Vrefs (V₃, V₇) for XP; and three read reference voltages Vrefs (V₂, V₄, V₆) are for UP. The read reference voltages for the respective pages are schematically shown by upward-pointing arrows with different lengths.

Like the Gray-code state representation shown in FIG. 4, there are multiple ways to achieve an 8-to-4 TLC state compression for a Gray code state representation shown in FIG. 9.

FIGS. 10-13 show four 8-to-4 TLC state compression schemes.

FIG. 10 is achieved by a first scheme of setting XP=(˜LP)|(˜UP), i.e., XP=(NOT LP) OR (NOT UP). The remaining 4 states are T1 (110), T2 (100), T5 (011) and T7 (101).

FIG. 11 is achieved by a second scheme of setting XP=LP|(˜UP), i.e., XP=LP OR (NOT UP). The remaining 4 states are T0 (111), T2 (100), T4 (010) and T7 (101).

FIG. 12 is achieved by a third scheme of setting XP=NOT (UP XOR LP). The remaining 4 states are T0 (111), T2 (100), T4 (010) and T6 (001).

Among these schemes shown in FIGS. 10-12, only the third scheme shown in FIG. 12 provides protection for both extra page (XP) and lower page (LP) while providing a large margin between two immediate neighboring states. Therefore, the third scheme shown in FIG. 12 is a fully protected 8-to-4 state compression scheme and provides a better scheme of 8-to-4 state compression than the first and second schemes shown in FIG. 10 and FIG. 11.

For the third scheme in FIG. 12, to reduce the read latency, XP and LP are used for data pages; UP is used for redundancy page. This is because, as described above, UP uses 3 read reference voltages while XP and LP use 2 read reference voltages in the Gray code state representation shown in FIG. 9.

If one of the data pages cannot be decoded, the redundancy page will be read and be decoded. If the redundancy can be decoded, the decoding-failed data page can be recovered by using the other data page and the redundancy page.

Specifically, if the data in the memory cell is written in the third scheme shown in FIG. 12, LP and UP can be decoded, however XP cannot, XP can be determined by XP=(NOT UP) XOR LP.

Similarly, FIG. 13 provides another fully protected 8-to-4 state compression scheme based on the same Gray-code state representation shown in FIG. 9. FIG. 13 is achieved by a fourth scheme of setting UP=(XP XOR LP). The remaining 4 states are T1 (110), T3 (000), T5 (011) and T7 (101).

### QLC Example 1

This is an example compressing 16 states to 8 states for a QLC cell.

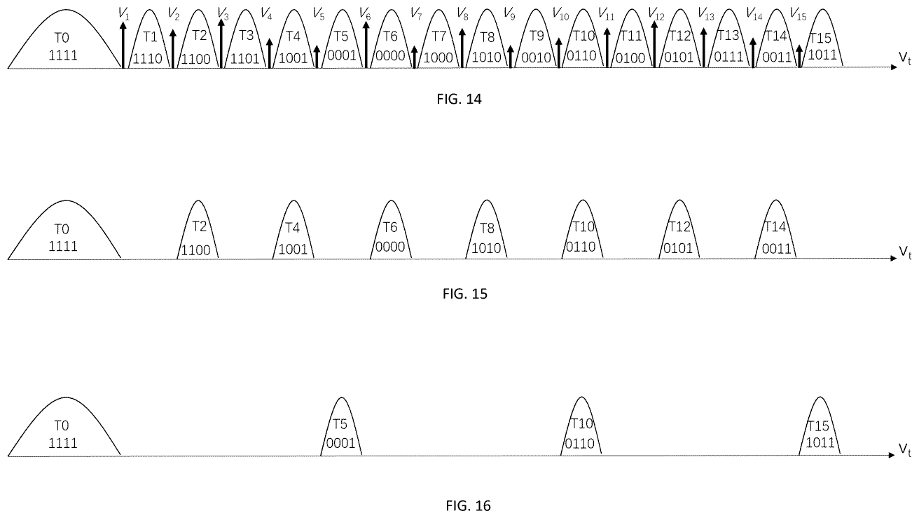

FIG. 14 shows the Gray code state representation in a normal QLC mode, which can be used in this example.

As shown in FIG. 14, in this Gray coding rule, 16 states T0, T1, T2, T3, T4, T5, T6, T7, T8, T9, T10, T11, T12, T13, T14 and T15 are mapped to 16 four-bit binary codes 1111, 1110, 1100, 1101, 1001, 0001, 0000, 1000, 1010, 0010, 0110, 0100, 0101, 0111, 0011 and 1011, respectively. As mentioned before, the first (left) bit corresponds to TP (Top Page), the second bit corresponds to UP (Upper Page), the third bit corresponds to MP (Middle Page) and the last (right) bit corresponds to LP (Lower Page).

The 16 states are defined by 15 read reference voltages V1 to V15.

Specifically, there are four read reference voltages Vrefs (V₁, V₃, V₆, V₁₂) for LP; four read reference voltages Vrefs (V₂, V₈, V₁₁, V₁₃) for MP; three read reference voltages Vrefs (V₄, V₁₀, V₁₄) for UP; and four read reference voltages Vrefs (V₅, V₇, V₉, V₁₅) for TP. The read reference voltages for the respective pages are schematically shown by upward-pointing arrows with different lengths.

In this example, LP, MP and UP can be used as three data pages to store user data, while TP can be used as redundancy page.

A 16-to-8 fully protected state compression scheme for QLC is achieved by setting TP=LP XOR MP XOR UP.

FIG. 15 shows the 16-to-8 compressed state representation of QLC Example 1.

As shown in FIG. 15, the remaining 8 states are T0 (1111), T2 (1100), T4 (1001), T6 (0000), T8 (1010), T10 (0110), T12 (0101), and T14 (0011).

When reading data from the memory cell, if any one of data pages LP, MP and UP cannot be decoded, successfully decoded TP could be used to recover the failed page.

### QLC Example 2

FIG. 16 shows the 16-to-4 compressed state representation of QLC Example 2. QLC Example 2 is based on the same Gray code state representation shown in FIG. 14.

It is possible that there is not a fully protected 16-to-4 state compression scheme for a Gray-code state representation. For example, no fully protected 16-to-4 state compression exists for the Gray-code state representation shown in FIG. 14.

For this kind of state compression scheme, (T0, T5, T10, T15) will be chosen to enlarge margins between any two neighboring states.

Also, in this example, TP and UP will be used as data page. And for this state compression scheme, LP and MP can be used as redundancy page to provide extra data protection for data in TP.

Several examples of the state compression scheme for TLC and QLC are described above.

In a TLC cell, if an 8-to-4 state compression scheme without any two immediate neighboring states satisfies one of the two encoding rules: XP=NOT (UP XOR LP), XP=UP XOR LP, it is a fully protected 8-to-4 state compression scheme. A page among LP, UP and XP with the max number of Vrefs can be used as the redundancy page and the other two pages can be used as data pages.

In a QLC cell, if a 16-to-8 state compression scheme without any two immediate neighboring states satisfies one of the two encoding rules: TP=NOT (UP XOR MP XOR LP), TP=UP XOR MP XOR LP, it is a fully protected 16-to-8 state compression scheme. A page among LP, MP, UP and TP with the max number of Vrefs can be used as the redundancy page and the other three pages can be used as data pages.

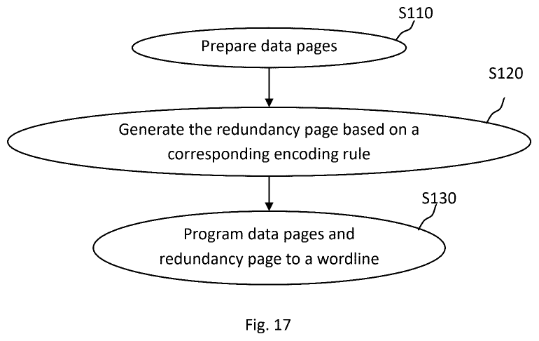

FIG. 17 is a schematic flow chart of a programing operation for a wordline with a state compression scheme of the disclosure.

The programing operation can be performed by the controller 102 of the system 100 as shown in FIG. 1.

As shown in FIG. 17, in step S110, data pages are prepared.

In step S120, the redundancy page is then generated (or set) based on a corresponding encoding rule.

As described in this disclosure, the redundancy page can be based on at least one page of the data pages.

And then, in step S130, the data pages and the redundancy page(s) are all programed to a wordline, to be written to the memory cells.

If the data stored in a state compressed memory cell is programed with a fully protected state compression scheme, failure of decoding of a data page can be recovered with the help of the redundancy page, when reading the data stored in the memory cell.

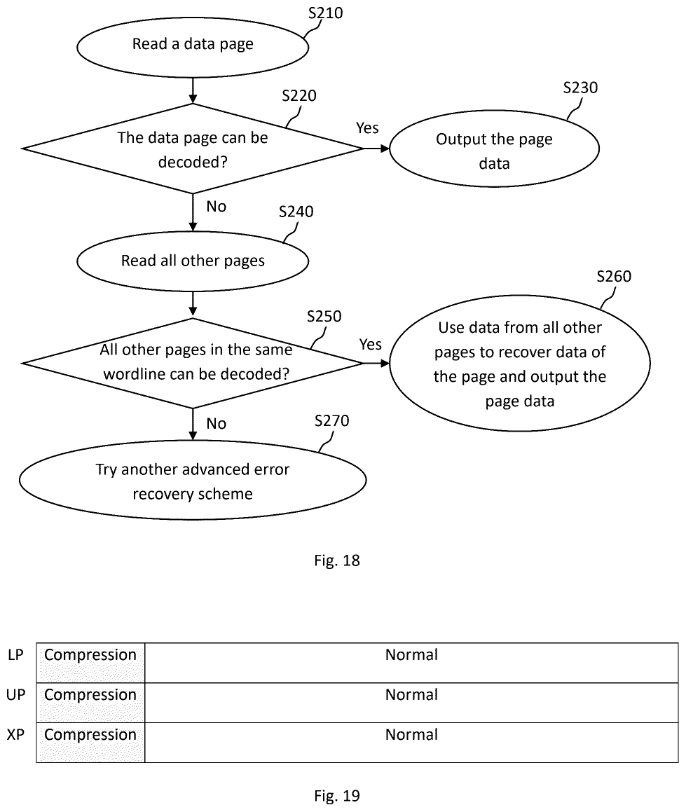

FIG. 18 is a schematic flow chart of a read operation for a wordline with a fully protected state compression scheme of the disclosure.

The read operation can be performed by the controller 102 of the system 100 as shown in FIG. 1.

FIG. 18 shows an example of reading a data page from a state-compressed memory cell with multiple pages.

As shown in FIG. 18, in step S210, a data page is read from the memory cell, for example, by using read reference voltages corresponding to this data page.

In step S220, it is checked whether the data page can be decoded. For example, the page can be decoded by ECC decoder.

If it can be decoded successfully, the process turns into step S230, outputting the page data as a result. And the process ends.

If it cannot be decoded successfully, the process turns into step S240, reading all other pages from the memory cell.

In step S250, it is checked whether all the other pages in the same wordline can be decoded.

If all the other pages in the same wordline can be decoded, the process turns into step S260, data from all these other pages is used to recover data of the page and output the page data as a result. And the process ends.

If any one of the other pages cannot be decoded successfully, the process turns into step S270, another advanced error recovery scheme can be further tried.

The state compression scheme proposed in this disclosure can be used by parts of a wordline.

FIG. 19 schematically shows partial page usage of state compression scheme in a TLC block.

As shown in FIG. 19, a portion of a TLC block, e.g., the first four bytes of three pages (LP, UP and XP) of a TLC wordline, are encoded by using a state compression scheme. The remaining portion of the TLC block, e.g., the remaining bytes of the wordline are programmed in a normal way.

Some attribute data of 64 bits such as programming temperature of the current wordline can be stored in the state compression portion, e.g., first four bytes of three pages, by using a fully protected 8-to-4 state compression scheme. Other space of the wordline remaining in normal mode can be used to store uncompressed main data.

Even if decoding attempts for the wordline with default Vrefs fail, the attribute data stored by using the 8-to-4 state compression scheme still can be acquired correctly and can be used to select right optimal Vrefs for next read retry because of the enhanced reliability and extra protection.

If reliability of attribute data would like to be improved further, an 8-to-2 state compression scheme can be used by providing a trade-off between data size and reliability.

With the new optimal Vrefs, the uncompressed main data can be decoded successfully.

Accordingly, the state compression scheme proposed in this disclosure provides a better reliability than normal TLC or QLC mode. Some critical data previously stored in SLC block can now be stored in state-compressed TLC or QLC memory cells.

Therefore, the state compression scheme can be used to reduce the number of SLC blocks in an SSD to improve the lifetime of the SSD.

As described above, for an 8-to-4 TLC state compression scheme and 16-to-8 QLC state compression scheme, fully protected state compression scheme can be found and used to provide extra data protection.

For 16-to-4 QLC state compression scheme, (T0, T5, T10, T15) state compression scheme will be used to provide better reliability.

To use the state-compress schemes proposed in this disclosure, the randomizer after ECC encoding engine should be disabled.

Further, the state compression schemes proposed in this disclosure can be used by either a whole wordline or a partial wordline.

The state compression schemes proposed in this disclosure can be applied to portion of blocks dynamically without need of converting a whole block to more reliable state like SLC. One example is when the host notifies SSD of data with important nature such as using write FUA (Forced Unit Access) command, the device can write those data in wordlines which uses state compression scheme.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A controller, comprising:
a processor configured to set values of D bits, based on values of M bits, wherein M is an integer greater than 0 and D is an integer greater than 0;
wherein the controller is configured to write the values of D bits and the values of M bits into a memory cell of a non-volatile memory.

2. The controller of claim 1, wherein the processor is configured to set the values of D bits using one or more results of one or more logic operations of one or more of the values of M bits.

3. The controller of claim 1, wherein D=1, D=2, or D=3.

4. The controller of claim 1, wherein M=1, M=2, M=3, or M=4.

5. The controller of claim 1, wherein the processor is configured to set the value of at least one bit among the D bits to the value of one bit among the M bits.

6. The controller of claim 1, wherein the processor is configured to set the value of at least one bit among the D bits to a negation of an exclusive disjunction of the values of two bits among the M bits.

7. The controller of claim 1, wherein the processor is configured to set the value of at least one bit among the D bits to a disjunction of a negation of the value of one bit among the M bits and a negation of the value of another bit among the M bits.

8. The controller of claim 1, wherein the processor is configured to set the value of at least one bit among the D bits to a disjunction of the value of one bit among the M bits and a negation of the value of another bit among the M bits.

9. The controller of claim 1, wherein the processor is configured to set the value of at least one bit among the D bits to an exclusive disjunction of the values of two bits among the M bits.

10. The controller of claim 1, wherein the processor is configured to set the value of at least one bit among the D bits to an exclusive disjunction of the value of a first bit and an exclusive disjunction of the value of a second bit and the value of a third bit, wherein the first bit, the second bit and the third bit are among the M bits.

11. The controller of claim 1, wherein the processor is configured to set the value of at least one bit among the D bits based on the value of only one bit among the M bits.

12. The controller of claim 1, wherein the processor is configured to set the value of at least one bit among the D bits based on the values of only two bits among the M bits.

13. A system, comprising the controller of claim 1, wherein the system is a solid-state drive (SSD), a flash drive, a mother board, a processor, a computer, a server, a gaming device, or a mobile device.

14. A controller configured to read values of M bits and values of D bits from a memory cell of a non-volatile memory, wherein M is an integer greater than 0 and D is an integer greater than 0;
wherein the controller comprises a processor configured to determine values of the M bits based on the values of the D bits.

15. The controller of claim 14, wherein D=1, D=2, or D=3.

16. The controller of claim 14, wherein M=1, M=2, M=3, or M=4.

17. The controller of claim 14, wherein the processor is configured to determine the value of at least one bit among the M bits as the value of one bit among the D bits.

18. The controller of claim 14, wherein the processor is configured to determine the value of at least one bit among the M bits as an exclusive disjunction of the value of another bit among the M bits and a negation of the value of one bit among the D bits, or configured to determine the value of at least one bit among the M bits as an exclusive disjunction of the value of one bit among the D bits and a negation of the value of another bit among the M bits.

19. The controller of claim 14, wherein the processor is configured to determine the value of at least one bit among the M bits based on the value of only one bit among the D bits.

20. The controller of claim 14, wherein the processor is configured to determine the value of at least one bit among the M bits based on the values of only two bits among the D bits.

21. A system, comprising the controller of claim 14, wherein the system is a solid-state drive (SSD), a flash drive, a mother board, a processor, a computer, a server, a gaming device, or a mobile device.
